(19) United States
(12) Patent Application Publication
(10) Pub. No.: US 2003/0113058 A1
(43) Pub. Date: Jun. 19, 2003

(54) Control system for dynamic gain equalization filter

(76) Inventor: John William Stayt JR., Schnecksville, PA (US)

Correspondence Address: Darius C. Gambino, Esq., Duane Morris, 36th Floor, One Liberty Place, Philadelphia, PA, 19103, US

(21) Appl. No.: 10/017,078

(22) Filed: Dec. 14, 2001

(51) Int. Cl. G02B 6/28

(52) U.S. Cl. 385/24

(57) ABSTRACT

A control system including an optical filter, an optical amplifier coupled to the optical filter, an optical channel monitor coupled to the optical filter, and a controller coupled to the optical channel monitor and the optical filter. The control system monitors the state of a plurality of filter elements within the optical filter, and adjusts power to the filter elements as needed.

### FIELD OF THE INVENTION

This present invention relates to a method and apparatus for controlling a silica waveguide dynamic gain equalization filter (DGEF).

### BACKGROUND OF THE INVENTION

Gain equalization techniques are increasingly being used to control optical spectrum profiles of transmitted or received signals, by varying the amplitude of the optical spectrum in certain frequency bands. One type of device that is presently used for performing gain equalization is the silica waveguide (SiWG) on a silicon substrate dynamic gain equalization filter (DGEF). The DGEF is a device which effectively controls an optical spectrum profile by varying the amplitude of the optical spectrum in specific frequency bands. Most DGEFs work independently of the International Telecommunications Union (ITU) grid spacing of the customer or end-user. The DGEF reduces power divergence at the receiver, and increases optical signal to noise ration (OSNR). The number of frequency bands is determined by the customer's needs, with fifteen (15) bands at the lower limit (course filter), and for silica waveguides, forty (40) bands at the upper limit (high resolution filter). As the channel count (i.e., the number of discrete channels in a particular frequency band) increases in the future dense wavelength division multiplexing (DWDM) systems, a greater number of bands are foreseen.

Design specifications which are important to consider in a DGEF design include: (a) dynamic range, (b) insertion loss, (c) wavelength range, (d) short-term and long-term stability. Insertion loss and wavelength range are fixed by the optical design of the waveguide, however, dynamic range and stability depend on the quality of the electronic circuitry. Low noise, high stability (i.e., extremely low drift) circuits are needed because these undesirable terms directly affect the optical signal. If the circuit ‘wiggles’ (i.e., allows for drift), the optical signal wiggles. If the bands drift in frequency then the optical signal attenuation is not accurately established. The dynamic range is easy to achieve with an unlimited power budget. However, a DGEF which fits into existing telecommunications systems will have a low power budget. Therefore, high performance circuits are needed which deliver power efficiently (low loss) to the DGEF elements. However, there presently exists no effective circuits for efficiently delivering power and controlling the output of a DGEF.

Thus, there is currently a need for a method and apparatus for controlling a filter for optical signals, such as a silica waveguide dynamic gain equalization filter (DGEF) which efficiently provides power to the DGEF.

### SUMMARY OF THE INVENTION

The present invention comprises a control system including: an optical filter, an optical amplifier coupled to the optical filter, an optical sensing device coupled to the optical filter; and a controller coupled to the optical sensing device and the optical filter.

The above and other advantages and features of the present invention will be better understood from the following detailed description of the exemplary embodiments of the invention which is provided in connection with the accompanying drawings.

### BREIF DESCRIPTION OF THE DRAWINGS

FIG. 1 is a block diagram showing a control system according to a first exemplary embodiment of the present invention.

FIG. 2 is a block diagram showing a control process for the control system shown in FIG. 1.

FIG. 3 is a state diagram for a controller according to a first exemplary embodiment of the present invention.

FIG. 4 is a block diagram showing a control process for a power control system according to a first exemplary embodiment of the present invention.

FIG. 5 is block diagram showing inputs and outputs to a microprocessor of a control system according to a first exemplary embodiment of the present invention.

FIG. 6 is a block diagram showing a firmware architecture according to a first exemplary embodiment of the present invention.

FIG. 7 is a block diagram showing a telecommunications system utilizing the DGEF control system according to a first exemplary embodiment of the present invention.

### DETAILED DESCRIPTION

The present invention comprises a method and apparatus for controlling a silica waveguide dynamic gain equalization filter (DGEF). The DGEF control system reduces power divergence at a signal receiver of a communications system, and increases optical signal to noise ratio (OSNR). Both of these characteristics extend the error free transmission distance of the communications system.

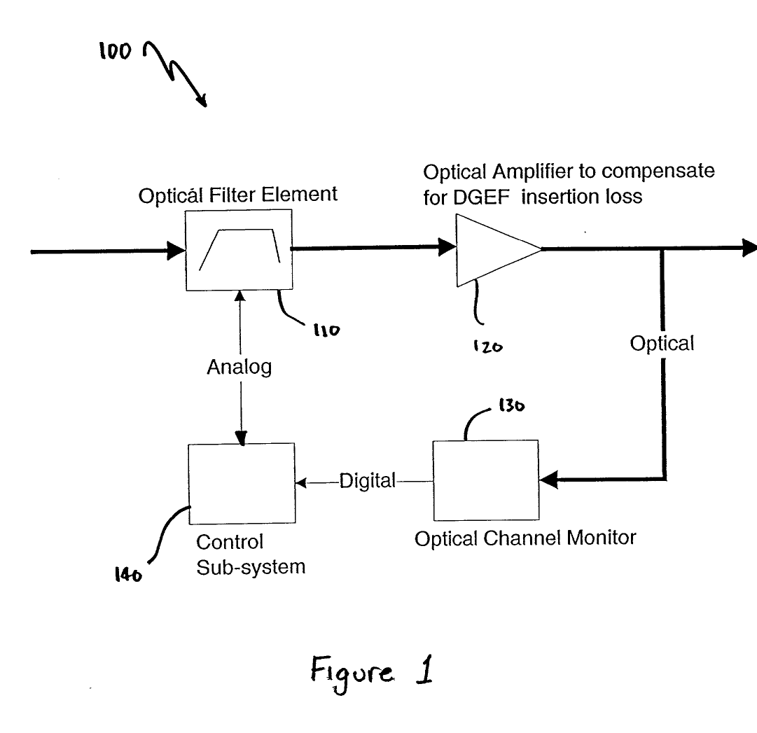

FIG. 1 shows a control system 100 according to an exemplary embodiment of the present invention. The control system 100 includes an optical filter 110 (e.g., dynamic gain equalization filter(DGEF)) which receives optical signals (from, for example, different subscribers of a telecommunications system), an optical amplifier 120, an optical channel monitor (OCM) 130, and a secondary control system 140.

One of the key elements of the present control system 100 is the optical channel monitor (OCM) 130. The OCM 130 measures optical signal intensity as a function of the wavelength of the optical signal. The OCM 130 measures the optical signal as contained within the optical fiber which carries the signal. Once a specific attenuation level is established, the control system 100 will not rely on the OCM 130, but rather on an electrical power monitoring system 800 which is part of the secondary control system 140 (See FIG. 8). If a change in attenuation is requested by the communications system (e.g., by, for example, the additional or deletion of certain wavelengths), then the OCM 130 is again utilized to provide optical feedback to the control system 100.

The data gathered by the OCM 130 is one of a plurality of inputs to the secondary control system 140. The shape of the DGEF 110 attenuation profile is system dependent, and may be (a) level, (b) tilted to compensate for wavelength dependent transmission losses, or (c) pre-distorted to correct for system non-linearity. Moreover, the DGEF control system 100 has three modes of operation: (1) adjust the optical spectrum based on OCM input (guided—mode 1), (2) self adjust and maintain the optical spectrum based on the OCM data already received (autonomous—mode 2), or (3) apply an attenuation profile under command from the host system (automatic—mode 3). The first mode of operation is primarily handled by the OCM 130, and the second and third modes of operation are primarily handled by the electrical power monitoring system 800 (FIG. 8). The secondary control system 140 includes a switch 810 which selects the particular mode of operation. When the switch 810 is in the position shown in FIG. 8, the OCM provides input data to the secondary control system 140 (mode 1). When the switch 810 is in the opposite position shown in FIG. 8, the electrical power monitoring system 800 controls (modes 2 & 3).

The present invention centers around the initial control being provided by the OCM 130, followed by supplemental control by the electrical power monitoring system 800 (FIG. 8) of the secondary control system 140. Essentially, the OCM 130 monitors wavelength profile during a change in wavelength (typically initiated by a user of the DGEF 110), and the electrical power monitoring system 800 maintains the selected profile over time and temperature changes. Besides the addition or deletion of wavelengths, the OCM 130 control can be triggered by other events, such as a change in the characteristics of the optical amplifier 120.

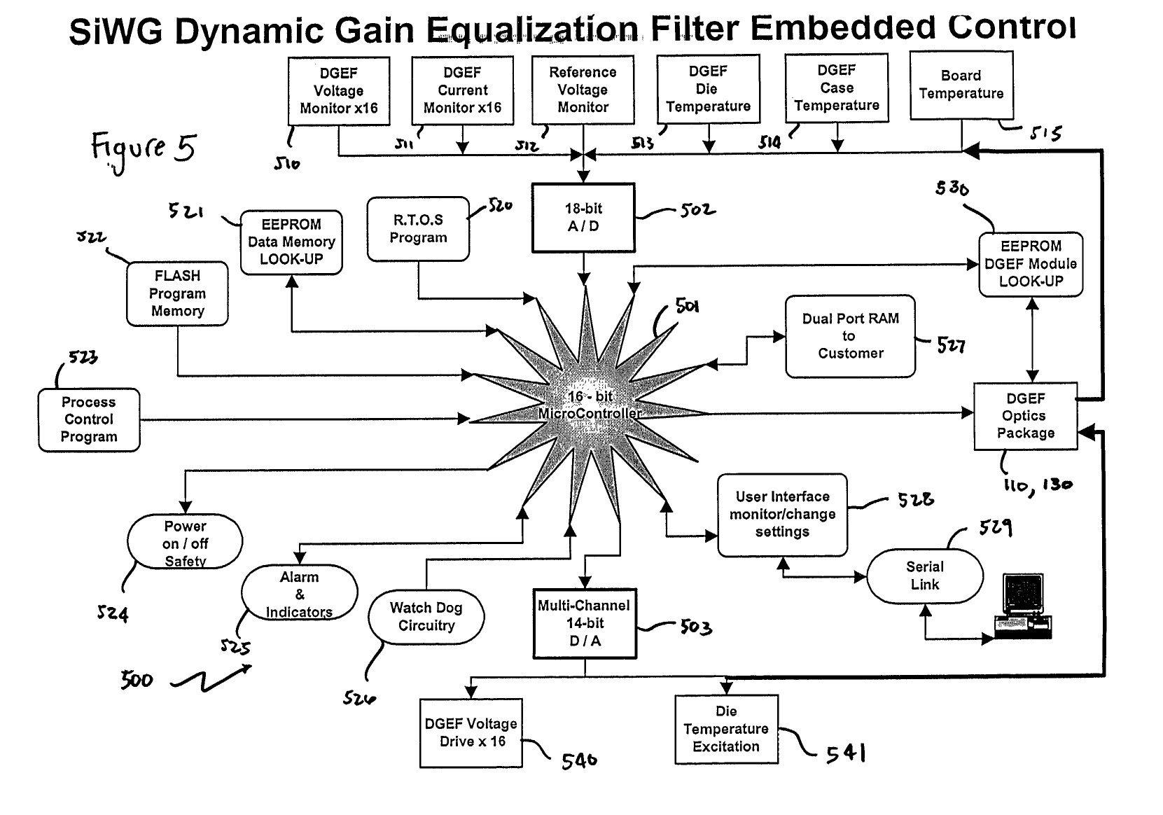

The operation of the control system 100 proceeds as described below. The OCM 130 monitors the signals contained within the optical fiber and feeds information on optical signal intensity and wavelength into a dual-port Random Access Memory (RAM) 527 (See FIG. 5) as two linked arrays. A serial port may be used to transmit signals from the OCM 130 to the dual-port RAM 527. Using this information, the secondary control system 140 calculates the new power required to change from the present attenuation level to the new attenuation level, and then applies this power to the individual control elements of the filter 110. There exists some overlap between the frequency bands being controlled, and therefore typically more than one control element of the filter 110 needs to be adjusted for a single frequency band attenuation change. Measurements by the OCM 130, and power control by the secondary control system 140 are effected until the desired attenuation levels are achieved. On average, four (4) to six (6) iterations are expected to obtain ±0.25 dB accuracy.

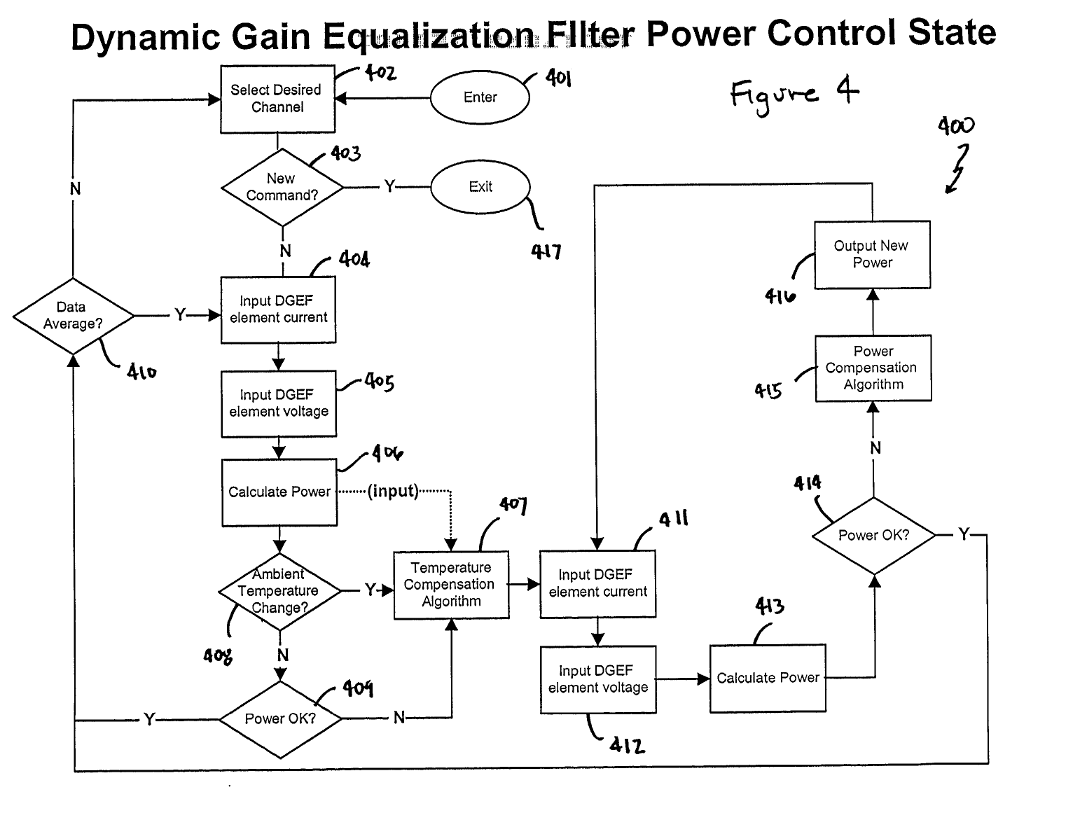

As stated above, once a desired attenuation level has been achieved, the OCM 130 is removed as the primary controller for the control system. An electrical power monitoring system 800 is used instead of the OCM 130 to maintain a constant power level to the DGEF elements. The electrical power monitoring system 800 includes a plurality of current sense resistors 820 which are coupled to the control elements 830 of the filter 110, for monitoring each frequency band. The differential voltage across each sense resistor and each control element is monitored by the electrical power monitoring system 800. The power dissipated by each DGEF element (determined by P=V*I) is determined and held constant for the duration of the specified attenuation profile. The resistance of each DGEF element is affected by the total power dissipated by neighboring DGEF elements. This resistance change introduces an error into the voltage measurement used for power calculation. The power control algorithm 415 (FIG. 4)in the secondary control system 140 compensates for this error.

If a change in attenuation is requested by the communications system, the OCM 130 is once again called upon to provide optical feedback to the filter 110 to set up the new attenuation profile. Once the new attenuation profile has been established, the electrical power monitoring system 800 again takes over to keep the attenuation profile established.

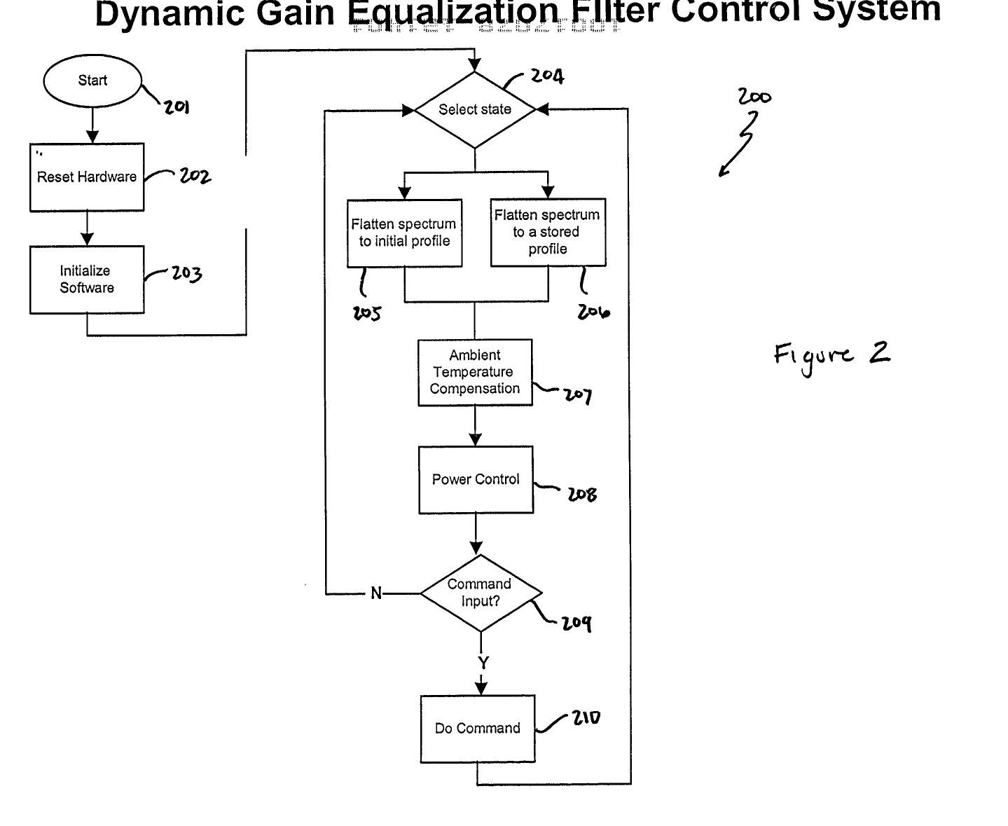

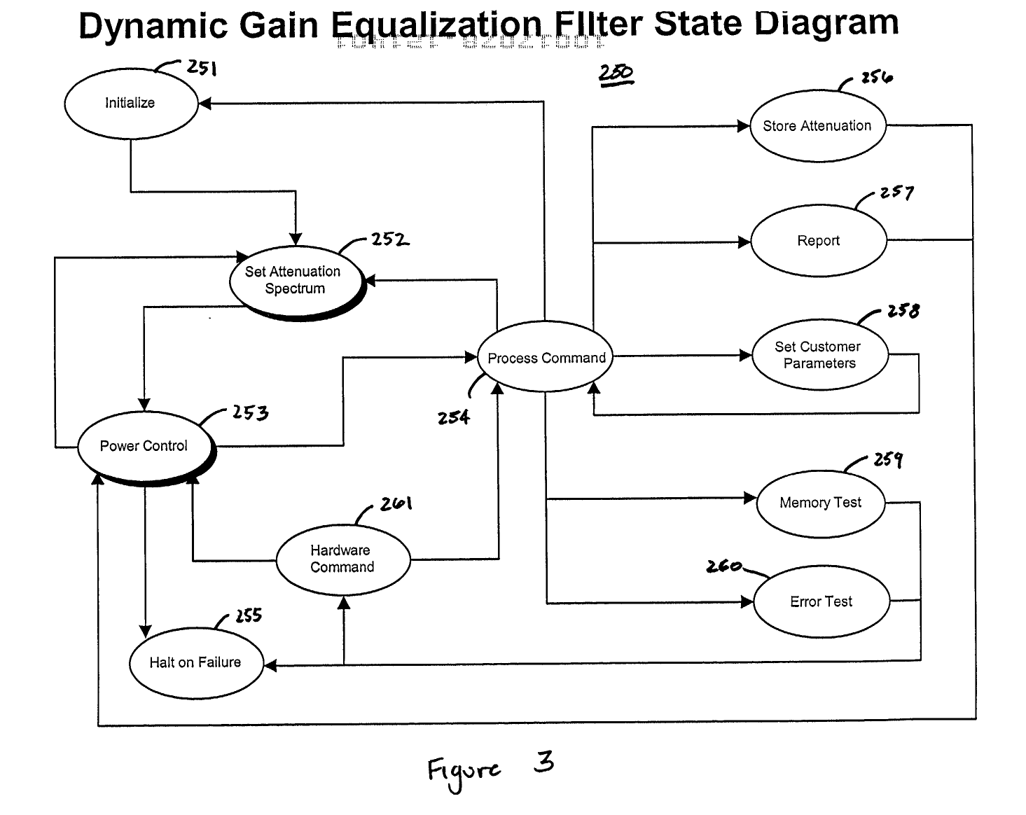

FIG. 2 is a block diagram showing the basic operation of a control process 200 for the secondary control system 140. The controller starts at step 201 after any power-up or reset. Then, the reset hardware is engaged at step 202. The reset hardware comprises circuit elements that assure an orderly start-up of the controller hardware along with protection of the filter 110 thermo-optics. Next, software for running the secondary control system 140 is initialized at step 203. During this step, a microprocessor 501 (See FIG. 5) of the secondary control system 140 is set up, controller memory (e.g., dual-port RAM 527) is cleared, flags are set, and the controlling firmware is initialized.

Next, an initial ‘state’ of the secondary control system 140 is selected (step 204). Then, an optical spectrum is flattened to either a selected ‘initial’ profile (step 205), or a selected ‘stored’ profile (step 206). The initial spectral profile would typically be selected by the manufacturer of the secondary control system 140, and would be stored in a look-up table (e.g., DGEF Module Look-Up EEPROM 530 or Data Memory Look-Up EEPROM 521) and initiated upon the first use of the microprocessor 501. The DGEF Module Look-Up EEPROM 530 preferably holds the individual DGEF specific calibration information and the default (‘flattened’) spectrum data. The Data Memory Look-Up EEPROM 521 preferably holds the user stored profiles and any other information that would be necessary to operate the DGEF. The initial spectral profile(s) would typically be stored in a look-up table or database (e.g., as a block of memory in EEPROM 521 or 530), and optionally updated by the firmware or via customer command. The stored spectral profiles are also preferably stored in a look-up table in either the same EEPROM (e.g., EEPROM 521 or 530) or a remotely located EEPROM that includes the last equalized state or from any of the states stored via customer command.

An ambient temperature compensation is performed at step 207 to correct for drift due to ambient temperature changes. A power controller which is initialized at step 208, compensates for variations of the filter 110 thermo-optics elements due to aging. It will be noted that the power controller 208 includes the electrical power monitoring system 800 as a portion thereof. Additionally, the power controller actively adjusts for ambient temperature changes by interacting with the ambient temperature compensation algorithm (step 207).

Commands are issued from the microprocessor 501 of the secondary control system 140 at step 209. If a command is entered (via interaction with the OCM 130 or other element of the DGEF control system 100), the command is processed at step 210. If no command is entered, the process returns to step 204 to check for selection of a new state. The most commonly used command is the command to set an attenuation spectrum. The microprocessor 501, which dictates the different functions of the secondary control system 140, issues commands based on the output of the OCM 130 (See FIG. 5). Although an OCM is used in the exemplary embodiment, it will be noted that an optical spectrum analyzer (OSA), a wavemeter, or other equivalent device may be used to obtain the spectral content of the optical signal.

FIG. 3 shows a state diagram 250 for the different states of the secondary control system 140. As explained above with reference to FIG. 2, a state of the secondary control system 140 is selected at step 204 of the control process 200.

The secondary control system 140 begins in an initialization state 251 where hardware and software are initialized as explained above (steps 201-203). The secondary control system 140 may then move to attenuation spectrum set state 252 where the power supplied to the elements of the filter 110 is varied in response to a set attenuation command (steps 209, 210). The subscriber (customer) may have to iterate through this state several times (e.g., 1-6) to achieve the desired degree of spectral flatness. The algorithms applied in this state correct for all electrical and optical interactions between the filter elements of the filter 110. Management of the overall power of the filter 110 is applied in this state.

From the attenuation spectrum set state 252, the secondary control system 140 may pass into a power control state 253. The power control state 253 is that state that the secondary control system 140 resides in most of the time. In this state, the filter 110 is actively kept stable as explained below with reference to FIG. 4. As discussed above with reference to FIG. 1, the DGEF control system 100 typically operates in one of three modes. In a first mode, an optical spectrum of the filter 110 is set based on data provided by the OCM 130. In a second mode, an attenuation profile is applied under command from the electrical power monitoring system 800. In a third mode, an attenuation profile is maintained over time and temperature changes by the electrical power monitoring system 800.

Referring again to FIG. 3, a process command state 254 may be entered from the power control state 253. From the process command state 254, one of five different software command states 256-260 may be entered. Each of the commands of the software command states are issued to the filter 110 from the microprocessor 501 of the secondary control system 140. A ‘store attenuation’ command state 256 saves an attenuation profile (i.e., the power needed in each filter heater element to achieve a known attenuation state). One or more states may be stored to achieve a specific spectral profile. A report state 257 allows the microprocessor 501 of the secondary control system 140 to read the current attenuation profile and status. In this state, electrical power, voltage, or current are returned to the microprocessor 501 of the secondary control system 140. A ‘set custom parameters’ state 258 allows for customization for specific customer needs. Examples are: setting fixed attenuation profiles and tilting the equalization profile to compensate for optical loss in the communications system. A memory test state 259 starts a test of the dual-port RAM 527 (See FIG. 5) that is the communications interface between the filter 110 and the secondary control system 140. Other on-board RAM/ROM may be exercised with this command as well. Finally, an error test state 260 simulates a hardware error; this state is used for system level testing.

A hardware command state 261 serves to capture all hardware interrupts. Depending on what attention the hardware has requested, control passes back to the power control state 253 or to the process command state 254. The halt on failure state 255 is executed when an unrecoverable hardware error occurs.

FIG. 4 is a block diagram showing the basic operation of a power control process 400. The power control process 400 is initiated when the secondary control system 140 enters the power control state 253 (See FIG. 3) at step 401. Once the control system 140 enters the power control state 253, a desired filter channel of the filter 110 is selected at step 402. This channel is preferably selected depending on the resolution of the filter 110. In particular, the ‘set attenuation’ state 252 and the power control state 253 apply the output of their algorithms to choose which filter channel(s) requires additional power to achieve the desired electro-optical attenuation profile.

Next, it is determined whether a new command has been sent to the microprocessor 501 of the secondary control system 140 at step 403. If a new command has been sent, the microprocessor 501 exits the power control state 253, and enters the state dictated by the new command (e.g., store attenuation state 256, report state 257, etc.) at step 417. A hardware failure will also halt the power control state 253 and force an exit at step 417. If no new command has been issued, the process proceeds to step 404 where a filter element current is input from an Analog to Digital (A/D) converter 502 (coupled to the respective DGEF filter elements) to the microprocessor's (501) dual-port RAM 527. Then, a filter element voltage is input from the A/D converter 502 to the dual-port RAM 527 at step 405.

Once the filter element current and voltage have been input, a filter element power is calculated at step 406 by microprocessor 501. As is well known in the art, power may be calculated by multiplying current by voltage (i.e., P (Watts)=V (Volts)*I (Amperes)). This calculated power value is then provided as an input to a temperature compensation algorithm at step 407. The resistance of each DGEF element is affected by the total power dissipated by neighboring DGEF elements. This resistance change introduces an error into the voltage measurement used for power calculation. The power control algorithm 415 (FIG. 4)in the secondary control system 140 compensates for this error. Additionally, the heat generated by each DGEF element introduces an error for which the power control algorithm 415 also compensates. This heat compensation significantly reduces thermal crosstalk between filter elements.

Next, an ambient temperature is compared to a stored ambient temperature value at step 408. If a temperature change is detected, the temperature compensation algorithm is engaged which utilizes the power value calculated at step 406 to anticipate and correct temperature changes due to pending power adjustments. If no change in ambient temperature is detected, the process proceeds to step 409 where it is determined if the ambient temperature change is within acceptable limits. If the temperature change is within acceptable limits, the power control process continues to step 410, where a data averaging is performed, if such has been enabled by the operator of the control system 100. If data averaging is enabled, the system continues to measure the same channel. It will be noted that alternate averaging schemes may be applied, such as measuring/controlling all channels before applying the next averaging cycle. Once the data averaging has been performed, the process returns to step 402 where a desired filter channel is selected. If it is determined that the temperature change is not within acceptable limits, the process proceeds directly to step 407 where the temperature compensation algorithm is engaged.

The temperature compensation algorithm engaged at step 408 compensates for changes in the optical attenuation spectrum due to ambient temperature changes. Ambient temperature affects the power balance of the filter heaters and also changes the stress/strain on the filter device itself. At step 408, both of these are compensated.

Once the ambient temperature has been numerically compensated for, a filter element current is input from A/D converter 502 to the microprocessor's (501) dual-port RAM 527 as before at step 404 (step 411). Then, a filter element voltage is input from A/D converter 502 to the microprocessor's (501) dual-port RAM 527 as before at step 405 (step 412). Again, the filter element power is calculated as in step 406 (step 413). Once the power has been calculated, the filter element power is tested to determine if it is within acceptable limits at step 414. If the power falls within the predetermined acceptable limits, data averaging is continued at step 410. If the power is not within the predetermined acceptable limits, a power compensation algorithm is initiated at step 415. The power compensation algorithm, applies an error calculator to minimize power error. Once a new power value has been calculated, the new power value is output at step 416. This new power value is applied to drive the DGEF filter elements to achieve the desired power. Typically, more than one filter element needs a new power level because of thermal crosstalk issues.

It will be noted that a thermoelectric cooler (TEC) may be employed to regulate the DGEF temperature as well. However, due to the lower power budget of the DGEF, a TEC would not typically be utilized. Of course, there will be other situations utilizing the present invention in which a TEC would be suitable for providing temperature control functions.

FIG. 5 is a block diagram showing the details of a 16-element DGEF control system 500, including the various inputs and outputs to and from a microprocessor 501. As discussed above, the microprocessor 501 controls all the operations of the secondary control system 140 of the DGEF control system 100 (See FIG. 1). Those of ordinary skill in the art will understand that although the control system 500 is discussed as a 16-element control system, any number of elements may be used without departing from the scope of the present invention. The control system 500 of FIG. 5 may be utilized as a 15 band DGEF with a common reference path, or an 8 band DGEF with balanced attenuators.

The microprocessor 501 receives the following analog inputs as processed through a Analog-to-Digital (A/D) converter 502: (a) a measured voltage value for each of the sixteen (16) filter elements of the filter 110 (block 510), (b) a measured current value for each of the sixteen (16) filter elements of the filter 110 (block 511), (c) a reference voltage value (block 512), (d) a filter die temperature value (block 513), (e) a filter case temperature value (block 514), and (f) a board temperature value (of the board carrying the filter 110, amplifier 120, OCM 130, and control system 140) (block 515). Each of these analog input signals is digitized by the A/D converter 502 and sent to the microprocessor 501 for processing.

The microprocessor 501 outputs the following analog outputs as processed through a Digital-to-Analog (D/A) converter 503: (a) a voltage drive signal for each of the sixteen (16) filter elements of the filter 110, and (b) a die temperature control signal for controlling the temperature of the filter die. The die temperature control signal comprises a pair of matched current sources that provides a drive signal to a resistance temperature detector (RTD) sensor (not shown) monitoring the DGEF die. Each of these analog output signals are converted from digital signals to analog by D/A converter 503 and sent to the filter 110.

The control system 500 also includes various other input and outputs as described below. A Real Time Operating System (RTOS) program provides a tasks to the microprocessor 501 on a time and priority schedule to guarantee real-time predictability (block 520). A Data Memory Look-Up Electrically Erasable Programmable Read-Only Memory (EEPROM) stores look up tables, calibration factors, serial numbers, and saved attenuation profiles (block 521). The EEPROM maintains its content even when power to the system is disabled, however, the contents thereof can only be changed under program control when the system is running. A flash memory stores operating programs and provides such programs to the microprocessor 501 (block 522). Like the EEPROM, the flash memory maintains its content even when power to the system is disabled, however, the contents thereof can only be changed under program control when the system is running.

A process control program provides commands to the microprocessor 501 as discussed above with reference to FIG. 3 (block 523). A power safety program assures that the DGEF elements are not damaged during power up and power down of the process(block 524). An alarm provides alerts to the operator of the system that certain tasks have been performed, or that certain failures have been encountered (block 525). Finally, ‘watch dog’ circuitry assures that the microprocessor 501 will reset in the event of a system lock-up (block 526). A timer is set and periodically updated when the system is functioning correctly. If the timer reset does not occur in the specified time, a hardware reset is performed to restart the control system 100.

As discussed previously, a dual-port Random Access Memory (RAM) stores digitized values for DGEF control elements voltage and current (block 527). A user interface permits a user or operator of the system to monitor and control the different functions of the microprocessor 501 (block 528). The user interface preferably connects to a personal or mainframe computer through a serial link (block 529). As stated above, a DGEF Module Look-Up EEPROM preferably holds the individual DGEF specific calibration information and the default (‘flattened’) spectrum data (block 530).

A DGEF Voltage Drive block 540 provides a voltage drive signal to the different control elements of the DGEF 110. Additionally, a Die Temperature Excitation block 541 provides a drive signal to the RTD temperature sensor monitoring the DGEF die. Blocks 540 and 541 comprise high power drive circuits that connect the microprocessor 501 to the DGEF heaters. Since the microprocessor 501 signals are low power high impedance signals, the drive circuits are needed to provide power to the low impedance DGEF heaters. While typically one would use a current drive to source a resistive element, a voltage drive design is disclosed here to minimize power losses in the circuitry. By providing only the voltage needed by the DGEF element, excess voltage is not dissipated by the driver transistors. This is a key factor in manufacturing a low power, high efficiency DGEF.

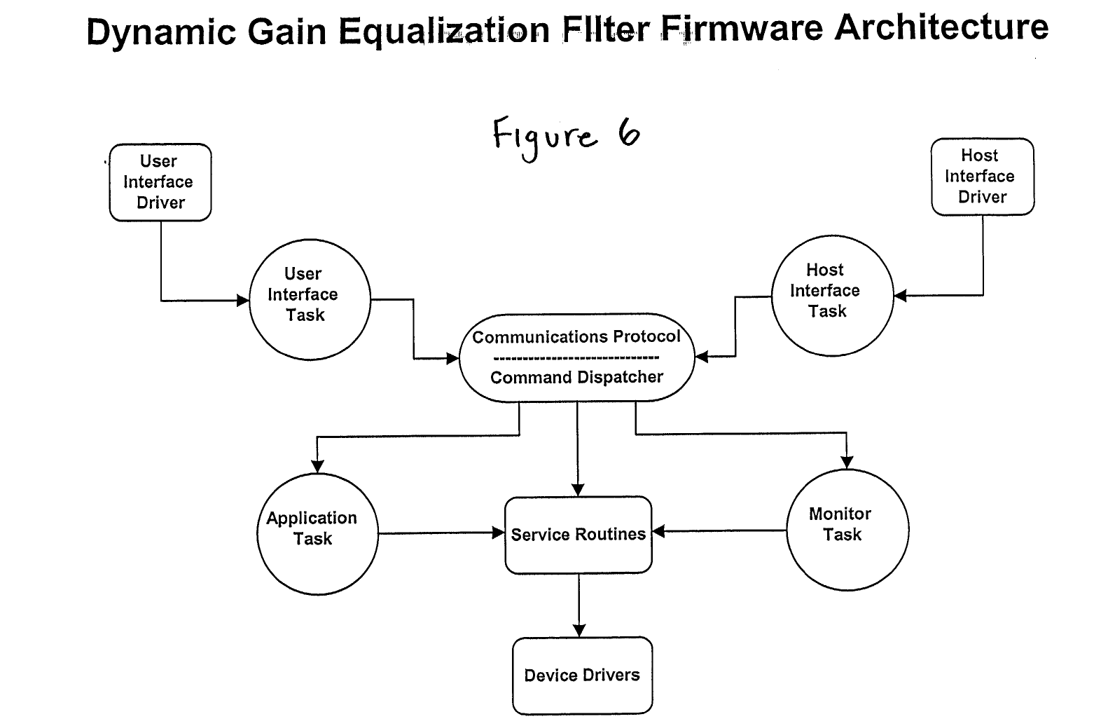

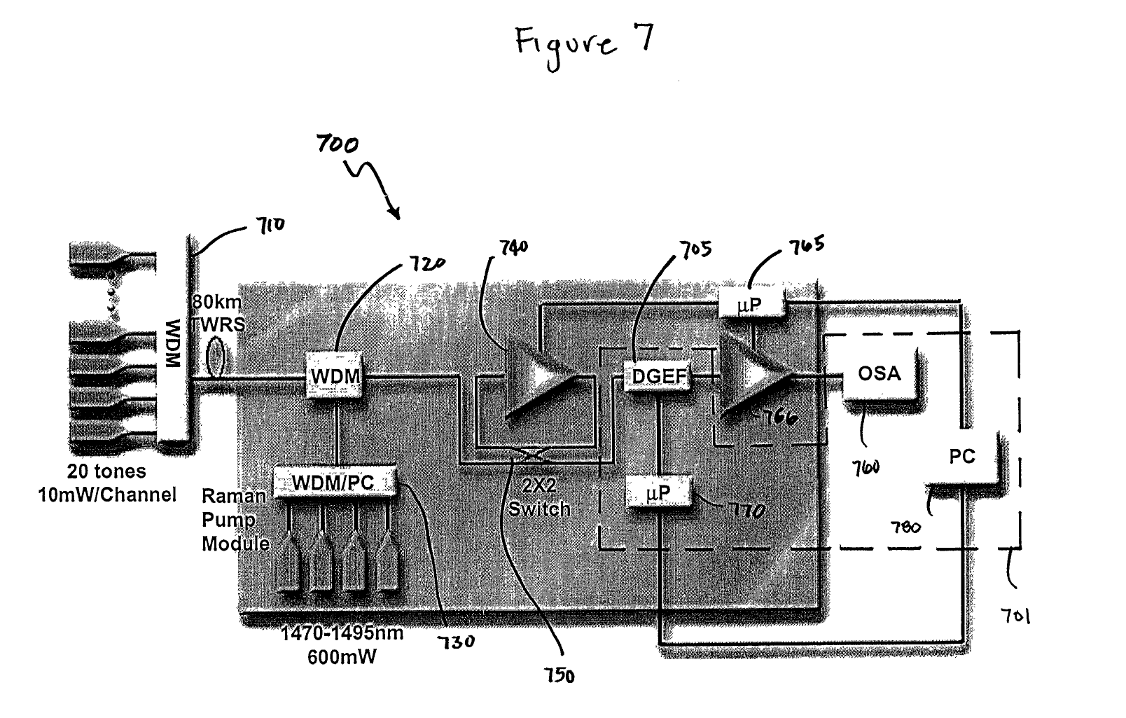

FIG. 6 shows a block diagram of a firmware operating system 600 according to an exemplary embodiment of the present invention. FIG. 6 is included for thoroughness to document the Real Time Operating System (RTOS) employed in the DGEF architecture (See block 520 in FIG. 5). This figure shows the interaction between the user (outside the DGEF module) and host (within the DGEF module) communications drivers and tasks. The hardware is serviced with the applications and monitor tasks to control the hardware device drivers.

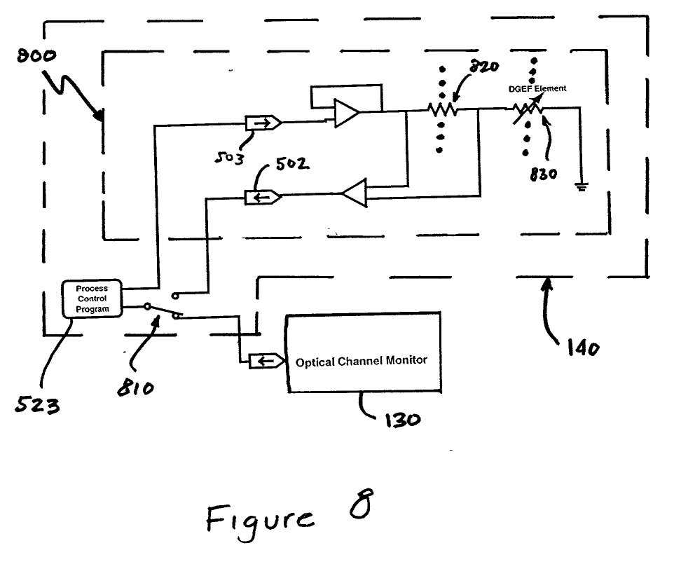

FIG. 7 shows an exemplary system 700 including a DGEF 705 and a DGEF control system 701, such as DGEF control system 100 described above. The system 700 includes twenty (20) lasers with data (tones) which are optically multiplexed via a Wave Division Multiplexer (WDM) 710, which, like the DGEF 110, may also formed from silica on silicon, or other WDM technology such as thin films. A WDM combiner 720 adds additional “pump” laser power into the signal fiber carrying the twenty multiplexed signals. Four Raman lasers are combined with another WDM/PC unit 730 which powers a Raman amplifier 740. The optical signal then flows to the Raman amplifier 740 via a 2 by 2 (2×2) optical switch 750. This optical switch 750 permits bypassing the Raman amplifier 740 to allow demonstration of the signal gain with and without the Raman amplifier. The DGEF 705 is next in the optical path. It smoothes out the spectrum as the present disclosure describes. An Erbium-doped optical amplifier 766 follows the DGEF 705 to add additional gain. An optical signal analyzer (OSA) 760 allows monitoring of the optical signals presented at the output of the optical amplifier 766. A first microprocessor 765 controls the optical amplifier 766 coupled to the output of the DGEF 705. A second microprocessor 770 controls the DGEF filter elements in response to the commands of a microprocessor of PC 780. The PC 780 also monitors the output of the OSA 760 in order to provide feedback to the DGEF 705, as discussed in the present application. It will be noted that the OSA 760 shown in FIG. 7 is comparable to the OCM 130 of FIG. 1, the DGEF 705 is comparable to the DGEF 110, and the microprocessor comparable to the control system 140.

Although the invention has been described in terms of exemplary embodiments, it is not limited thereto. Rather, the appended claims should be construed broadly, to include other variants and embodiments of the invention which may be made by those skilled in the art without departing from the scope and range of equivalents of the invention.

What is claimed is:

1. A control system comprising:
an optical filter including at least one filter element;
an optical amplifier coupled to the optical filter;
an optical sensing device coupled to the optical filter; and,
a secondary control system coupled to the optical sensing device and the optical filter.

2. The control system of claim 1, wherein the optical sensing device comprises an optical channel monitor.

3. The control system of claim 1, wherein optical sensing device comprises an optical spectrum analyzer.

4. The control system of claim 1, wherein optical sensing device comprises a wave meter.

5. The control system of claim 1, wherein the secondary control system controls the voltage applied to the at least one filter element of the optical filter.

6. The control system of claim 1, wherein the optical sensing device monitors the output voltage of the at least one filter element.

7. The control system of claim 1, wherein the optical sensing device monitors the output current of the at least one filter element.

8. The control system of claim 1, wherein the secondary control system includes an electrical power monitoring system which operates to maintain the power applied to the at least one filter element.

9. The control system of claim 1, wherein the secondary control system comprises:
a microcontroller;
an analog-to-digital converter coupled to the microcontroller for delivering at least one analog signal to the microcontroller in digital format; and,
a digital-to-analog converter coupled to the microcontroller for converting at least one digital signal from the microcontroller to at least one analog control signal.

10. The control system of claim 9, wherein the analog-to-digital converter converts an analog voltage associated with the at least one filter element into a digital reference voltage.

11. The control system of claim 9, wherein the digital-to-analog converter converts an digital voltage value produced by the microprocessor into a analog drive voltage for application to the at least one filter element.

12. The control system of claim 1, wherein the secondary control system has at least three modes of operation, including:
a first mode wherein an optical spectrum of the optical filter is adjusted based on data from the optical sensing device;
a second mode wherein the optical spectrum of the optical filter is maintained based on the data received from the optical sensing device; and,
a third mode wherein an attenuation profile is applied to the optical filter under command from a microprocessor.

13. A method controlling the gain of an optical filter, comprising the steps of:
transmitting a signal from an optical filter to an optical amplifier;
monitoring the output of the optical amplifier;
providing feedback to a secondary control system coupled to the optical filter, said feedback indicating an output voltage of at least one element of the optical filter.

14. The method of claim 13, comprising the further step of:
determining in the secondary control system, from the output voltage of the at least one element of the optical filter, whether a power drive signal should be applied to the at least one element.

15. The method of claim 13, wherein the at least one element of the optical filter comprises a plurality of elements.

16. A method controlling an optical filter, comprising the steps of:
setting an initial state of a control system for controlling the optical filter;
setting an optical spectrum profile for the optical filter to either an initial profile or a stored profile;
compensating for ambient temperature changes; and,
initializing a power controller for controlling the power applied to different elements of the optical filter.

17. The method of claim 16, comprising the further step of:
compensating for thermal crosstalk between elements of the optical filter.

18. The method of claim 16, comprising the further step of:
compensating for resistance changes in the resistance of at least one element of the optical filter.

19. The method of claim 16, wherein the step of compensating for ambient temperature changes comprises compensating for ambient temperature changes utilizing a thermoelectric cooler.

20. The method of claim 16, wherein the power controller performs the following steps in controlling the power applied to the different elements of the optical filter:
selecting a desired filter element of the optical filter;
receiving a current value for the selected filter element;
receiving a voltage value for the selected filter element;
calculating a power associated with the selected filter element;
determining if the calculated power is within acceptable limits; and
transmitting a power control signal to the selected filter element if the calculated power is not within acceptable limits.

21. An optical transmission system comprising:
a plurality of optical transmission lines coupled to a wave division multiplexer, said wave division multiplexer selectively transmitting a plurality of optical signals to an optical filter;
an optical amplifier coupled to the optical filter;
an optical sensing device coupled to the optical filter; and,
a secondary control system coupled to the optical sensing device and the optical filter.

22. The optical transmission system of claim 21, further comprising an optical amplifier coupled between the wave division multiplexer and the optical filter.
